(19) United States
(12) Patent Application Publication
(10) Pub. No.: US 2018/0245680 A1
(43) Pub. Date: Aug. 30, 2018

(54) Gearwheel for a balance shaft and balance shaft

(71) Applicants: Hirschvogel Umformtechnik GmbH, Denklingen (DE); Bayerische Motoren Werke Aktiengesellschaft, Munich (DE)

(72) Inventors: Hans-Jürgen Britzger, Denklingen (DE); Franz Kreil, Pliening (DE); Bernhard Jakob, Penzing (DE); Rupert Turrina, Fuchstal (DE); Thomas Wiesenberger, Hofstetten (DE)

(21) Appl. No.: 15/905,975

(22) Filed: Feb. 27, 2018

(30) Foreign Application Priority Data
Feb. 28, 2017 (DE) 10 2017 104 159.1

(51) Int. Cl. F16H 55/17; B21K 1/30; B21K 25/00

(52) U.S. Cl. CPC F16H 55/17; F16F 15/264; B21K 25/00; B21K 1/30

(57) ABSTRACT

A gearwheel for a balance shaft includes a gear ring and a gear core, where the gear ring is fabricated of a first metal and the gear core of a second metal, where the second metal has a lower density than the first metal, where the gear core and the gear ring are compressed to each other at an inner surface of the gear ring, the gearwheel further including formfitting elements to form an additional formfitting between the gear ring and the gear core, where, as seen in a circumferential direction along the inner surface of the gear ring, a distance between two adjacent formfitting elements is larger than an extension of the formfitting element along the circumferential direction.

### CROSS REFERENCE TO RELATED APPLICATION

This application is related to and claims the benefit of German Patent Application Number 10 2017 104 159.1 filed on Feb. 28, 2017, the contents of which are herein incorporated by reference in their entirety.

### TECHNICAL FIELD

The disclosure relates to a gearwheel for a balance shaft and a balance shaft.

### BACKGROUND

Balance shafts are well known from prior art and are used in vehicles to reduce or eliminate free inertia forces of an engine, especially of a reciprocating piston engine, so as to minimize any operating noise and vibrations. For this purpose, imbalances, preferably in the form of eccentric weights, are attached to or formed at the balance shaft. The inertia forces thereby created counteract those of a crank drive. In this respect, the balance shafts are synchronously driven by gear wheels.

In view of general weight reduction of vehicle components it would be advantageous, to be able to provide a gearwheel, which, on the one hand, is more lightweight compared to prior art gear wheels and on the other hand tolerates the expected loads.

From the document DE 10 2015 009 051 A1, a hybrid gear wheel is known that consists of a gear ring and a gear core, the gear ring and the gear core being made from different metals.

### BRIEF SUMMARY

The disclosure provides a gearwheel for a balance shaft that is reduced in weight in relation to those known from prior art, without the stability of the gear wheel being jeopardized under the loads that are to be expected during operation in the long run.

A gearwheel for a balance shaft is provided, wherein the gearwheel comprises a gear ring and a gear core, wherein the gear ring is manufactured of a first metal and the gear core is manufactured of a second metal, wherein the second metal has lower density than the first metal, wherein the gear core and the gear ring are compressed with each other at an inner surface of the gear ring, wherein the gearwheel comprises formfitting elements to form an additional formfitting between the gear ring and the gear core, wherein in a circumferential direction, as viewed along the inner surface of the gear ring, a distance between two adjacent formfitting elements is larger than an extension of the formfitting element along the circumferential direction.

In relation to prior art, selective regulation traction and formfitting caused by compressing between the gear core and the gear ring has been proven as especially advantageous for permanent connection thereof. The ratio of the contributions to formfitting and force closure may advantageously be adjusted or affected, respectively, by way of the distance between the two adjacent projections, and may especially be adapted to conditions that are set by the respective field of application for the gearwheel. By selection of the first metal and of the second metal, especially a weight reduction of more than 30% may be realized. For example, the embodiment of the invention allows providing a hybrid gear wheel having minimum influence to the design of the balance shaft in view of imbalance thereof. The first metal, for example, is a steel, especially a hardened and/or sintered steel, and the second metal is a light metal, such as e.g. aluminum or magnesium. It furthermore has been shown to be especially advantageous for the teeth of the gear ring that especially are under extreme stress while employing the gear wheel to be manufactured of a loadable metal, for example a sintered steel. It is especially preferred that the width of the gear ring extending in the radial direction is dimensioned dependent on the loads to be expected. It is especially advantageous to the balance shafts that the width of the gear ring, as seen in the radial direction, is more than twice as large as the height of the individual teeth of the gear ring, as seen in the radial direction. In the manufactured state, the gear ring especially surrounds the gear core, at least in certain areas. If the formfitting element have different extensions along the circumferential direction, preferably the mean value thereof is of relevance. Basically, as a distance or extension along the circumferential direction, respectively, the length of a circular arc section is to be understood, and the extension of the formfitting element, for example, is measured at its widest region.

According to an especially preferred embodiment of the present disclosure it is provided for the formfitting element or for the formfitting elements to be formed, respectively, as a projection at the inner surface of the gear ring. The projections are facing the gear core. Due to the compression of the second metal in the areas between the projections, the projections form-fittingly cooperate with the gear core, as seen in the circumferential direction. In this way, the connection between the gear core and the gear ring is advantageously reinforced in the interface area thereof. Simultaneously, the spacing between the individual projections allows for simple, uniform and uncomplicated shaping. Preferably, the projections maximally project 0.5 to 8 mm, preferably between 1 to 6 mm, or especially preferred between 1.5 and 5 mm from the inner surface of the gear ring. It is also considered, all projections to uniformly project, or individual projections to differ from each other in view of their projection depth. In an advantageous embodiment, the projections are forged thereto.

Alternatively or additionally, it is provided for the formfitting element to be formed as a bolt or tension spring incorporated in a bore. For this, the gear ring is firstly compressed with the gear core. Subsequently, a recess, especially in the form of a bore, is incorporated in the interface area between the gear ring and the gear core. In this recess or bore, respectively, a bolt or a tension spring may be incorporated to form a formfitting. For example, the bolt is a rivet, by means of which another formfitting may be achieved in the axial direction. It is preferred that the tension spring is annularly formed and is compressed or biased in the recess, respectively, such that the reset force presses against an inner wall of the recess and, in this way, is fixed within the recess. It is also conceivable that different formfitting element, especially different formfitting elements, are realized in a gearwheel.

In another embodiment of the present disclosure, it is provided for the gear core to have a sleeve region, wherein an inner surface of the sleeve region is conically or cylindrically formed. Via the sleeve region, the gearwheel may be pushed or mounted onto the balance shaft, respectively. It is especially provided, that the gearwheel is to be flush with the front side of the sleeve region or the front side of the gear core, respectively, at a side in axial direction. Furthermore, it preferably is provided for the sleeve region to axially protrude beyond the gear at a side opposite of the flush closure. For example, the sleeve region extends along the axial direction between 3 to 15 times as far as the gear ring along the axial direction. To form a connection with the balance shaft, in the case of a conically extending inner surface, an end element, for example in the form of a screw, is provided, forming the closure of the balance shaft in the axial direction. The end element preferably abuts the sleeve region with its collar element, as viewed in the axial direction.

It is suitably provided for the gear core to have a thread in the sleeve region, especially at an inner surface, or for the sleeve region at its front side or its outer shell side, to have one or more recesses to accommodate drivers, for example in the form of a Hirth coupling. In this way, a rotationally fixed coupling between the gearwheel and the balance shaft may advantageously be realized. It is also conceivable for the recesses to be realized at the balance shaft and the driver to be realized at gear wheel. The system having a recess and recess for the gear wheels is especially provided with a cylindrically shaped contour at the inner surface of the sleeve region. It is also conceivable for the balance shaft and the gearwheel to comprise a system having only one single driver and one recess. In the case of a conical track of the inner surface of the sleeve region, especially a thread on the inner surface of the sleeve region is provided, via which thread the gearwheel may be fitted onto or may be removed from a partially conically extending region of the balance shaft, respectively.

According to another aspect of the present disclosure, it is provided for the formfitting element to be uniformly distributed along the inner surface of the gear ring, wherein especially two respective formfitting element are oppositely arranged on the inner surface of the gear ring. Especially, the formfitting element are formed and/or are arranged along the circumferential direction such that they do not affect the imbalance of the balance shaft or selectively contribute to the imbalance by the non-uniformly distribution of the formfitting means. Preferably, for uniform distribution, an even number of formfitting means is provided. For example, the formfitting means, as seen in the circumferential direction, are arranged offset by 90°, offset by 45° or offset by 22.5°.

In another embodiment of the present disclosure, it is provided for the gear ring to have an inclined panel at its inner surface. The inclined panel advantageously promotes connection of the gear ring and the gear core in during assembling. For example, the inclined panel is formed as a step peripherally surrounding the front side on the inner surface. Such an inclined panel advantageously operates as a compression aid during compression of the gear core and the gear ring. In this context, it is conceivable for the inclined panel to completely circumferentially extend along the inner surface. Alternatively, it may also be considered for the inclined panels to be formed with projections in the regions, preferably to be formed exclusively in the regions with projections. For example, the inclined panel is part of the projection at the front side thereof.

In another embodiment of the present disclosure it is provided for the distance between two formfitting elements adjacent to each other in the circumferential direction to be 2 to 10 times, preferably 3 to 8 times and especially preferred 4 to 6 times as large as the extension of the formfitting means along the circumferential direction, especially in the widest region of the formfitting element along the circumferential direction. By way of this spacing, it advantageously is possible, for the gear core sufficiently abuts the inner surface of the gear ring to form an effective force fitting between the gear core and the gear ring along the circumferential direction.

According to another embodiment of the present disclosure, it is provided for the projection to have a curved contour, a curved contour tapering towards the center, or a triangularly shaped contour, especially at the side facing the gear core. In this way, gap effect during compression of the gear core is being counteracted, which, for example, otherwise could arise in a tapering contour of the projection.

Preferably, it is provided for the gear core in the sleeve region, especially on the outside of the sleeve region, to have notches, for example in the form of axially extending channels or radially extending holes. In this way, the overall weight may advantageously be further reduced. The recesses and/or holes, as seen in the circumferential direction, are preferably uniformly distributed, so that no additional imbalance by the gear wheel is caused. It is furthermore preferably provided for the axially extending channels to taper in the direction of the gear ring.

It is also conceivable for the ratio between der radial extension of the gear ring and the radial extension of the gear core is formed depending on the load to be expected. In this way, the ratio between the material composition of the first metal and the second metal for weight reduction of the overall gear wheel may advantageously can be adapted as optimally as possible, without jeopardizing the loadability of the manufactured gear wheel. It may also be considered that the ratio between the radial extension of the gear ring and the radial extension of the gear core is based on empirical values.

According to another embodiment of the present disclosure, it is provided for additional formfitting elements form a formfitting in the axial direction and/or in a direction parallel to the circumferential direction. For example, the gear ring has projection at its inner surface, which, as seen in the axial direction, only extends in certain areas, for example only extends 0.05 to 0.2 times as far as the overall extension of the inner surface in the axial direction. Preferably, the gear core comprises an indentation formed complementary to the projection, into which the projection engage to form the axial formfitting.

The present disclosure further provides a balance shaft having a gearwheel according to the disclosure. All characteristics described for the gearwheel according to the disclosure and the advantages may analogously also be transferred to the balance shaft according to the disclosure and vice versa.

Moreover, a process is provided for manufacturing of a gear wheel. All characteristics and the advantages thereof described for the gearwheel according to the disclosure may analogously also be transferred to the process according to the disclosure and vice versa. A process for the manufacture of a gear wheel according to the disclosure is provided, comprising the steps of:
providing a gear ring, preferably by way of a sinter technology, and a slug for the gear core
concentrically arranging the slug within the gear ring; and
forge-shaping the slug into the gear core,
   wherein the gear core is compressed with the gear ring to form a traction area and a formfitting area, especially in the region of a formfitting element.

Especially, it is provided for the slug to be cold deformed to form the gear core. Preferably, a force axially acts on the slug is operable, especially a force that corresponds to a weight of about 200 t. The manufacturing of the gear ring by way of sinter technology has been proven to especially cost-effective.

According to another embodiment of the present disclosure, it is provided for an outer circumference of the slug to become enlarged in the radial direction by forge-shaping. The slug especially will be crimped by the axially acting force such that the material of the slug will be displaced in the radial direction until the material, i.e. the second metal, abuts the inner surface of the gear ring to form a formfitting.

In another embodiment of the present disclosure, it is provided to realize a cavity, especially a conical or cylindrical cavity, in the gear core, which is compressed into the gear ring by shaping, to form the sleeve region. The cavity is formed by metal cutting, for example by a milling procedure.

Preferably, it is provided for the gear ring to be inserted into a fixing mold complementary configured to the outside of the gear ring. Especially, the teeth of the interlocking planarly abut the fixing mold on the outside of the gear ring. This advantageously counteracts damaging the gear, which otherwise could arise in the development of loads during compression of the gear core with the gear ring.

In an alternative embodiment it is provided for the gear ring to be provided as a ring, especially as a ring without an outer contour, and, following compression of the gear ring with the gear core, to realize an outer contour, especially an interlocking, at the gear ring. The ring, during compression, preferably planarly abuts a fixing mold having no inner contour. By post-realization of the interlocking, a round track as exact as possible may advantageously be assured in the manufacturing process of the teeth by metal cutting.

### BRIEF DESCRIPTION OF THE DRAWINGS

Further advantages and characteristics will arise from the subsequent description of preferred embodiments of the disclosure, by making reference to the appended figures, wherein:

FIG. 1: is a balance shaft having a gearwheel according to a preferred embodiment of the present disclosure;

FIG. 2: is a sectional view of the gear wheel of FIG. 1;

FIG. 3 is a gearwheel according to another preferred embodiment of the present disclosure;

FIGS. 4a and 4b are schematic representations of a process for the manufacture of a gear wheel according to the present disclosure;

FIG. 5 is a gearwheel according to another, second embodiment of the present disclosure.

### DETAILED DESCRIPTION

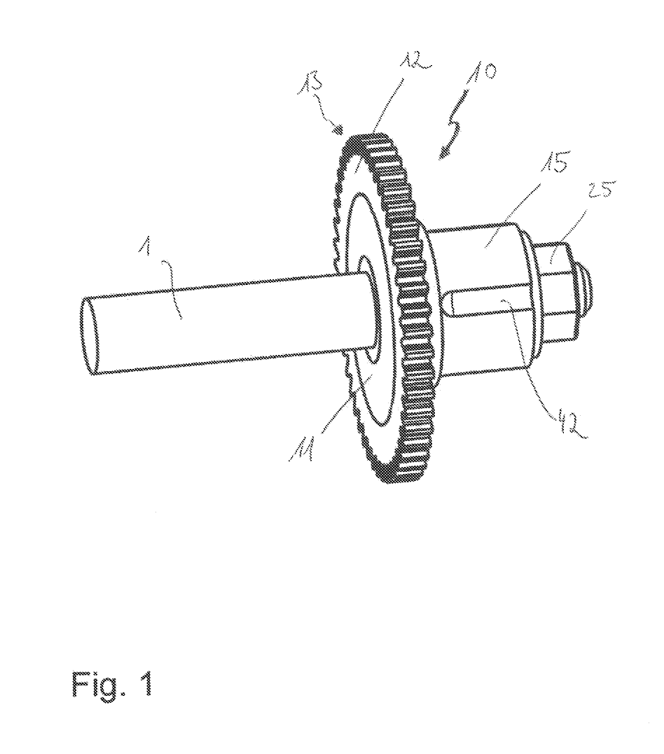

In FIG. 1 a balance shaft 1 having a gearwheel 10 according to a preferred embodiment of the present disclosure is presented. Such balance shafts 1, in vehicles, are to reduce or to eliminate the free inertia forces of an engine, especially of a reciprocating piston engine, so as to decrease any operating noise and vibrations. For this, imbalances, preferably eccentric weights are attached or formed to the balance shaft. The inertia forces thus created counteract those of a crank drive. The balance shafts 1 are then synchronously driven by gear wheels 10. In the represented embodiment, the gearwheel 10 is arranged at the end of the balance shaft 1, and is especially pushed onto the end of the balance shaft 1 and is non-rotatably connected to the balance shaft 1. The gearwheel 10 has a sleeve region 14 that preferably concentrically extends to the outer circumference of the gear wheel 10 and extends axially when the gearwheel is mounted on the balance shaft 1. For accommodation of the balance shaft 1, the sleeve region 15 provides a cavity 14, which actually is conically formed and, in the mounted state, is tapering in the direction of a front side of the end of the balance shaft 1, over which the gearwheel 10 is attached onto the balance shaft 1. For fixing the gear wheel 10, for example, an end element 25, for example a screw, is provided, cooperating via a thread with the gearwheel 10 and terminating the balance shaft 1 in the axial direction. In an alternative embodiment, it is conceivable for the sleeve region 15 to provide a cylindrical cavity 14. For the non-rotatable connection with the balance shaft 1 it is provided for the gearwheel 10 and the balance shaft 1 to be connected to each other via a driver. For example, the sleeve region 15, at its front side, as seen in the axial direction, comprises one or more recesses, into which the driver engages or vice versa. Alternatively, it is conceivable for the gearwheel to have a Hirth interlocking at its front side.

To reduce the overall weight of the gear wheel 10, it is provided for the gearwheel 10 to comprise a gear ring 12 and a gear core 11, wherein the gear ring 11 comprises a first metal and the gear core 12 comprises a seconds metal. The density of the second metal is thereby lower than the density of the first metal. For example, the gear ring 12 is fabricated of a steel, preferably a sintered and/or hardened steel, and the gear core 11 is fabricated of aluminum or magnesium. In this way, a weight reduction of more than 30% may advantageously be achieved with respect to a gearwheel 10 that is fully made of steel. For the realization of such a hybrid gear wheel, it is especially provided for the gear core 11 to be compressed with an inner surface 16 of the gear ring 12. In this way, a force-fitting connection between the gear ring 12 and the gear core 11 may be achieved. In addition, it is preferably provided for the gear ring 12 to have projections 17 at its inner surface 16 radially facing the center Z of the gear ring 12. By way of these projections 17, a formfitting between the projection 17 and the compressed gear core 11 may be achieved in addition to the force closure along the inner surface 16 of the gear ring 12. In this way, an especially stable and durable hybrid connection is advantageously forged. It is provided for the projections 17 to uniformly distribute along the inner surface 16. Especially, as seen in the circumferential direction U, a distance between two adjacent projections 17 is larger than an extension e of the projection 17 dimensioned in the circumferential direction U. In this way, in the region between two projections 17, a sufficiently large contact surface for a force fitting is provided, and simultaneously the connection 17 may be improved by the formfitting. For example, as seen in the circumferential direction, a projection 17 is disposed every 10°, every 40°, every 60°, every 90° or every 120°.

For the manufacture of the gear wheel 10, a gear ring 12 and a gear core 11 are provided. The gear ring 12 preferably is inserted in a tailor made manner into a fixing mold complementary configured to the interlocking of the gear ring 12, wherein the individual teeth planarly abut an interlocking 13 with their outside extending in the circumferential direction U on the inner surface of the fixing mold. Preferably, the fixing mold is not exactly formed as a counter contour, as demolding or ejecting, respectively, would be hindered by the surfaces totally abutting the fixing mold. Instead, the fixing mold has a counter contour, which is configured such that the teeth within the flanks are supported on a portion of the surface. This, advantageously simplifies removal from the fixing mold. In this way, the probability for eventual damages by slightly expanding the gear ring that might arise in subsequent forging-in the inner core is advantageously reduced. Alternatively, it is also conceivable for the gear ring 12 is initially be provided as a ring and the interlocking is realized following connection with the gear core 11. It is preferred that an appropriate fixing mold is provided, the abutting surface of which is devoid of any structure to allow planar abutting for the outer contour of the ring. It has been proven that by post-manufacture by machining of the outer contour of the gear ring 12 a round track as exact as possible may be assured. A slug is disposed concentrically to the gear ring 12 in the gear ring 12. By a force acting to the slug in the axial direction, for example with a force, corresponding to a weight of essentially 200 t, the slug is cold deformed such that the material of the slug, i.e. the second metal, is forced into the radial direction, thus forming form-fitting connection to the projections 17 and a force-fitting connection with the areas between den projections 17. Subsequently, for forming a sleeve region 15, a bore is incorporated into a gear core 11 formed of the slug, to form a cavity 14. Finally, the manufactured gearwheel 10 is non-rotatably fixed onto the balance shaft 1. Advantageously, the outer contours and/or the inner contours, such as e.g. the interlocking, the projections and/or a driver, will be punched out on the gear core and/or the gear ring or be cut out by a laser, e.g. a CO₂ laser, and are preferably cut out of a sheet metal. Post-processing is only required regarding the interlocking. The advantage of such a close-contour final fabrication is a faster final fabrication and a more tool-protecting end processing.

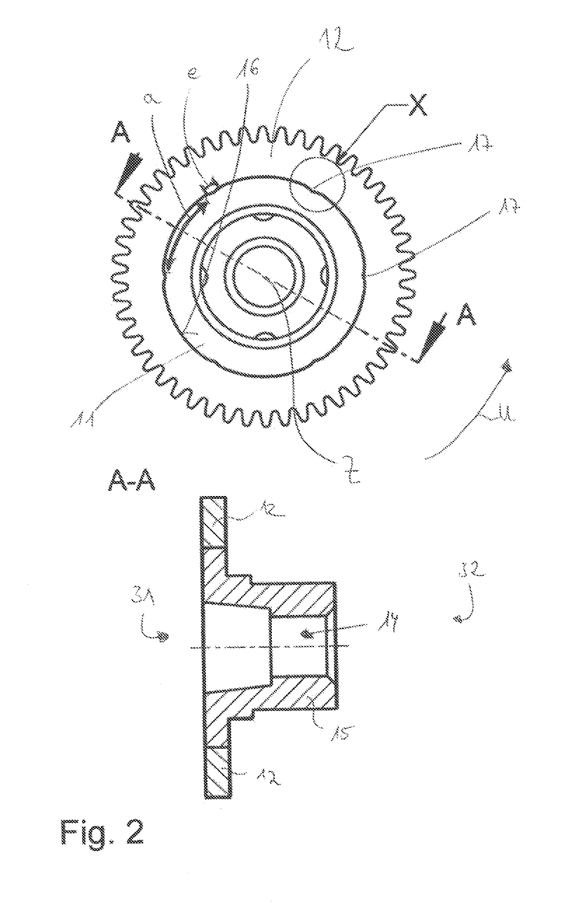

In FIG. 2 the gearwheel 10 of FIG. 1 is represented in a plan view (top) and in a sectional view (bottom). In the embodiment represented, the sleeve region 15 at its inner surface 16 is formed both cylindrically and conically. Especially, a first opening 31 provided by the cavity 14 of the sleeve region 15 on the side comprising the gear ring 12 is larger than the second opening 32 oppositely situated, as seen in the axial direction. Moreover, the cavity at the side facing the second opening 32 is conically formed. Furthermore, it is provided for the gear ring 12 to be flush with the front side of the sleeve region 15 or of the gear core 11, respectively. A projection 17 is to be found in the region referred to by X. It is furthermore preferably provided for the distance a between two formfitting elements adjacent to each other in the circumferential direction U is 2 to 10 times, preferably 3 to 8 times and especially preferred 4 to 6 times as large as the extension e of the formfitting element along the circumferential direction U, especially at a widest region of the formfitting element along the circumferential direction U.

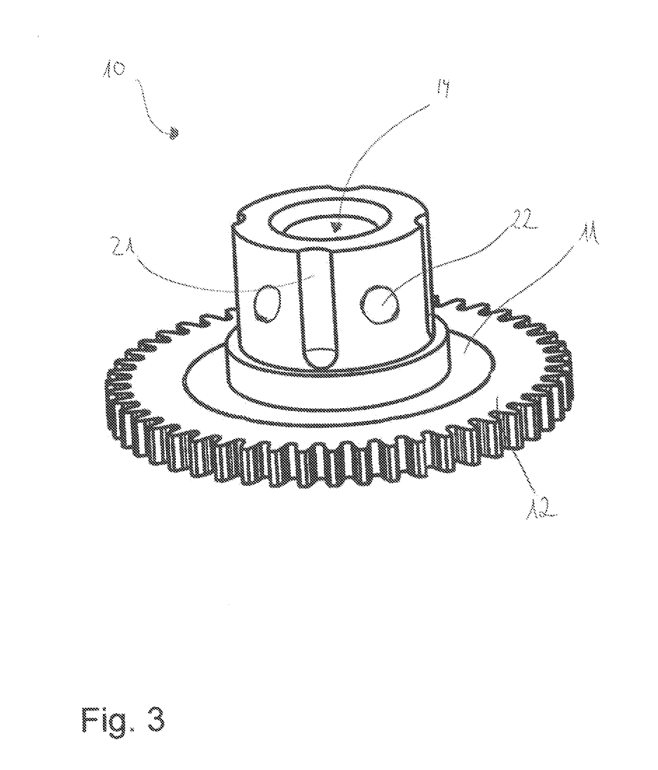

In FIG. 3, a gearwheel 10 according to another exemplary embodiment of the present disclosure is represented. The gearwheel 10 essentially corresponds to the gearwheel 10 from FIG. 2. In addition to the characteristics from the FIG. 2, it is provided in the embodiment of FIG. 3 that in the sleeve region 15, for further weight reduction, channels 21, especially axially extending channels are incorporated, and channels 21 and holes 22 are incorporated towards the front side, which preferably are formed to taper in the axial direction. Preferably, the channels 21 extend on the outside of the sleeve region.

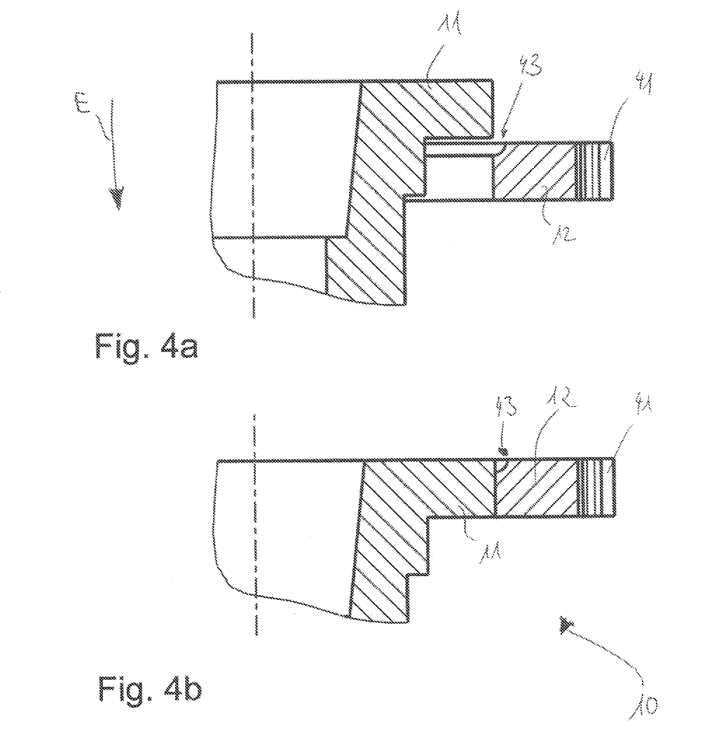

In the FIGS. 4a and 4b a process for manufacturing of a gear wheel 10 according to prior art is schematically represented. For this purpose, it is provided for the gear ring 12 to be inserted in a fixing mold 41. In the fixing mold 41, the gear ring 12 with its outside, especially with the interlocking 13, preferably abuts the inner surface of fixing mold 41 while completely surrounding the circumference, the fixing mold 41 thereby supporting or promoting the interlocking 13 in subsequent deformation or subsequent compression, respectively. In FIG. 4a, a state is illustrated, wherein a gear core is inserted as a prefabricated part along a pressing direction E into the gear ring 12, especially into the cavity thereof that is limited by its inner surface 16. Insertion is especially done via the side of the hollow area or of the gear ring 12, respectively, whereon an inclined panel 43 is formed. For example, the inclined panel 43 is integrated as a step into the projection 17. FIG. 4b shows the gearwheel 10 following deformation of the gear cores 11. In this process, it has been proven to be disadvantageous for a required inclined panel to minimize the pressing surface and, in certain areas, not to cause force-fitting abutment between the inner portion and the outer portion. Thus, dimensioning must be larger, to achieve the same pressing surface as with the deformation process. Consequently higher component weight will result.

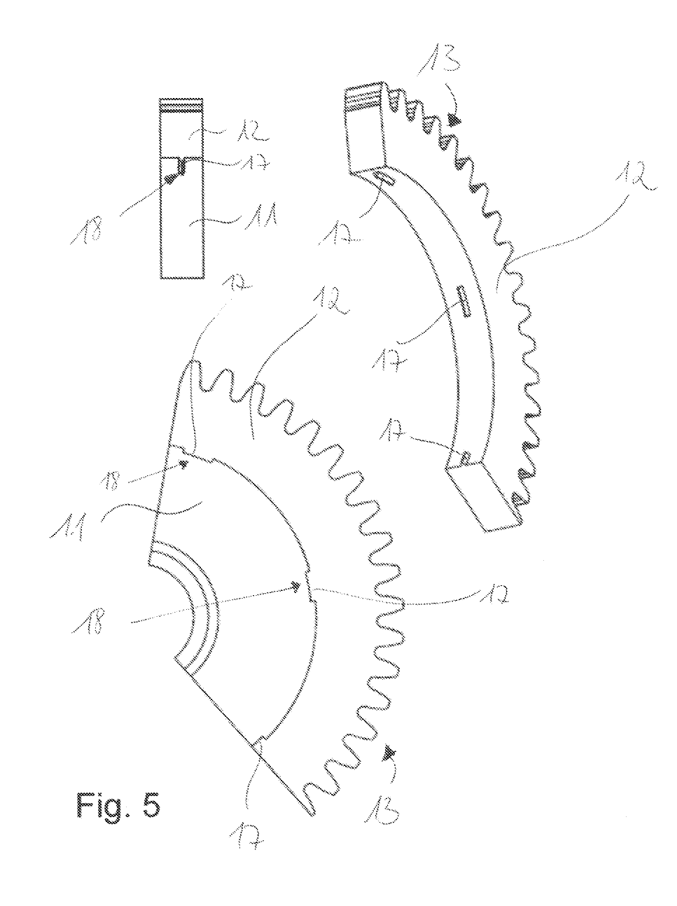

In FIG. 5, a gearwheel 10 according to another second embodiment of the present disclosure is represented. This embodiment essentially differs from the preceding ones only in that the formfitting element not only form-fittingly fixes the gear core 11 in a direction parallel extending to the circumferential direction, but in addition provides an axially acting formfitting. In this way, the gear ring 12 and the gear core 11 are fixed both in the circumferential direction and in the axial direction, following compression. For this, the gear ring 12, at its inner surface, comprises a bar-like projection 17 that extends along the circumferential direction. Furthermore, the bar-like projection 17, essentially as viewed in the axial direction, is centrally arranged or is arranged at the inner surface. Moreover, the projection 17 preferably only extends 0.05 to 0.2 times the overall length of the inner surface of the gear ring 12 in the axial direction, as seen in the axial direction. Moreover, the projection 17 is configured in the form of a pointed roof, as seen in the axial direction. It has been proven for such projections 17, especially during sintering, to be advantageously manufactured without additionally cost. Furthermore, it is provided for the gear core 11 to comprise an indentation 18 or notch, respectively, complementary to the projection 17, into which the projection 17 engages during and/or following compression to form the axial or circumferential formfitting.

1. Gearwheel for a balance shaft, comprising:
a gear ring and
a gear core,
wherein the gear ring is manufactured of a first metal and the gear core is manufactured of a second metal,
wherein the second metal has a lower density than the first metal,
wherein the gear core and the gear ring are compressed with each other at an inner surface of the gear ring,
the gearwheel further comprising:
formfitting elements configured to form an additional formfitting between the gear ring and the gear core,
wherein, as seen in a circumferential direction along the inner surface of the gear ring, a distance between two adjacent formfitting elements is larger than an extension of the formfitting element along the circumferential direction.

2. Gearwheel according to claim 1, wherein at least one of the formfitting elements are formed as a projection on the inner surface of the gear ring.

3. Gearwheel according to claim 1, wherein at least one of the formfitting elements is formed as a bolt or tension spring incorporated into a bore.

4. Gearwheel according to claim 1, wherein the gear core comprises a sleeve region, wherein an inner surface of the sleeve region is conically or cylindrically formed.

5. Gearwheel according to claim 4, wherein the gear core, in the sleeve region, at its inner surface, comprises a thread, or the sleeve region, at its front side or outer shell side, comprises one or more recesses to accommodate drivers.

6. Gearwheel according to claim 1, wherein the formfitting elements are uniformly distributed along the inner surface of the gear ring, wherein two respective formfitting elements are oppositely disposed on the inner surface of the gear ring.

7. Gearwheel according to claim 1, wherein the distance between two formfitting elements adjacent to each other in the circumferential direction is 2 to 10 times as large as the extension of the formfitting element along the circumferential direction at a widest region of the formfitting element along the circumferential direction.

8. Gearwheel according to claim 1, wherein the projection has a curved contour, a curved contour tapering to the center or a triangular-type of contour.

9. Gearwheel according to claim 1, wherein the gear core, on an outside of the sleeve region, comprises notches in the form of axial extending channels.

10. Gearwheel according to claim 1, wherein an additional formfitting element forms a formfitting in an axial direction and/or in one of the directions parallel to the circumferential direction.

11. Balance shaft having a gearwheel according to claim 1.

12. Process for manufacturing a gear wheel according to claim 1, comprising the steps:
providing a gear ring, by way of a sinter technology, and a slug for the gear core;
concentrically arranging the slug within the gear ring; and
forge-shaping the slug into the gear core,
wherein the gear core is compressed with the gear ring to form a traction area and a formfitting area.

13. Process according to claim 12, wherein, during forge-shaping, an outer circumference of the slug, is increased in radial direction.

14. Process according to claim 12, further comprising forming into the gear core, which is compressed into the gear ring by deformation, a conical or cylindrical cavity realized to form the sleeve region.

15. Process according to claim 12, wherein the gear ring is inserted into a fixing mold complementary configured to the outside of the gear ring.

16. Process according to claim 12, wherein the gear ring is provided as a ring without outer contour, and following compression of the gear ring with the gear core, an outer contour, an interlocking, is realized at the gear ring.
